(19) United States
(12) Patent Application Publication
(10) Pub. No.: US 2009/0132327 A1
(43) Pub. Date: May 21, 2009

(54) SYSTEM AND METHOD FOR SELLING COMMUNICATION SERVICES

(75) Inventors: JEREMY SULLINS, BLUE SPRINGS, MO (US); MOHAMMED KATIBEH, RICHARDSON, TX (US); ROBERT M. CLARK, CRESTWOOD, MO (US)

Correspondence Address: AT&T Legal Department - AS;Attn: Patent Docketing, Room 2A-207, One AT&T Way, Bedminster, NJ, 07921, US

(73) Assignee: AT&T KNOWLEDGE VENTURES, L.P., RENO, NV (US)

(21) Appl. No.: 11/941,516

(22) Filed: Nov. 16, 2007

(51) Int. Cl. G06Q 30/00; G06Q 10/00

(52) U.S. Cl. 705/9; 705/14

(57) ABSTRACT

A system that incorporates teachings of the present disclosure may include, for example, a communication device having a controller to receive from a service center a request directing a field service agent utilizing the communication device to fulfill a service order of a customer, receive from the service center information identifying one or more services of the communication system to which the customer has not subscribed, and present the one or more unsubscribed services to assist the field service agent in selling the customer at least one among the one or more unsubscribed services. Other embodiments are disclosed.

### FIELD OF THE DISCLOSURE

The present disclosure relates generally to communication services and more specifically to a system and method for selling communication services.

### BACKGROUND

It is common today for telecommunication service providers to offer traditional circuit-switched and/or Internet-based voice, video or data services. For consumers this means more service options from which to choose. It often happens that once a consumer selects a service option the consumer is less prone to stay attuned to service upgrades or the addition of new services by the service provider.

### BRIEF DESCRIPTION OF THE DRAWINGS

FIGS. 1-2 depicts an exemplary embodiment of a communication system;

FIG. 3 depicts an exemplary method operating in portions of the communication system; and

FIG. 4 is a diagrammatic representation of a machine in the form of a computer system within which a set of instructions, when executed, may cause the machine to perform any one or more of the methodologies discussed herein.

### DETAILED DESCRIPTION

In one embodiment of the present disclosure, a computer-readable storage medium can have computer instructions for receiving from a customer a service request associated with a service provided by a communication system, generating a service order to fulfill the service request, identifying one or more services of the communication system to which the customer has not subscribe, determining a location of the customer, directing a field service agent to fulfill the service order at the location of the customer, and informing the field service agent of the one or more unsubscribed services to assist the field service agent in selling at least one among the one or more unsubscribed services.

In one embodiment of the present disclosure, a communication device can have a controller to receive from a service center a request directing a field service agent utilizing the communication device to fulfill a service order of a customer. The service order can be associated with a service of a communication system. The controller can be further adapted to receive from the service center information identifying one or more services of the communication system to which the customer has not subscribed, and present the one or more unsubscribed services to assist the field service agent in selling the customer at least one among the one or more unsubscribed services.

In one embodiment of the present disclosure, method can involve presenting a field service agent a service order of a customer and information identifying one or more services of a communication system to which the customer has not subscribed.

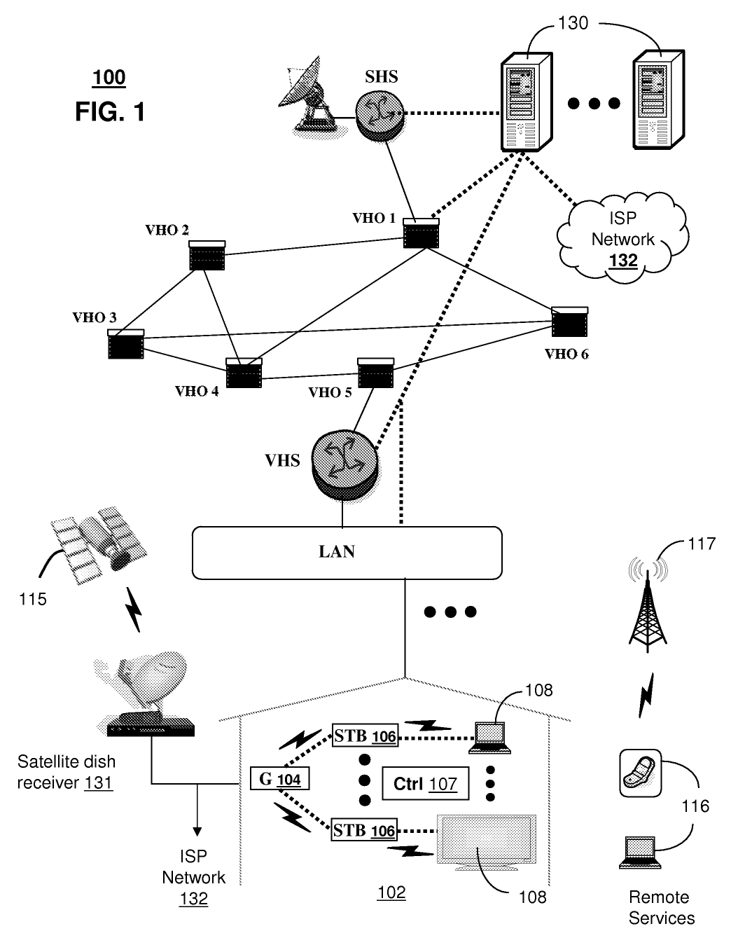

FIG. 1 depicts an exemplary embodiment of a communication system 100. The communication system 100 can represent an IPTV broadcast media system. In a typical IPTV infrastructure, there is at least one super head office server (SHS) which receives national media programs from satellite and/or media servers from service providers of multimedia broadcast channels. In the present context, media programs can represent audio only content, video only content, and/or combinations thereof. The SHS server forwards IP packets associated with the media content to video head servers (VHS) via a network of video head offices (VHO) according to a common multicast communication method.

The VHS then distributes multimedia broadcast programs to commercial and/or residential buildings 102 housing a gateway 104 (e.g., a residential gateway or RG) over a local area network (LAN). The gateway 104 distributes broadcast signals to media receivers 106 such as Set-Top Boxes (STBs) which in turn present broadcast selections to media devices 108 such as computers or television units managed in some instances by a media controller 107 (e.g., an infrared or RF remote control). Unicast traffic can also be exchanged between the media receivers 106 and subsystems of the IPTV media system for services such as video-on-demand (VoD).

The IPTV media system can be coupled to one or more computing devices 130 that can operate in part as a service center which for example provides registration services for new customers and can serve existing customers to add or modify existing service subscriptions. The service center can also be used for managing subscriber accounts, billing, and for deploying field service agents to fulfill service orders for new and existing customers. The computing devices can also provide portal services over an Internet Service Provider (ISP) network 132 to fixed media devices 108 or portable communication devices 116 by way of a wireless base station 117 such as in a cellular communication network operating with common protocols (GSM, CDMA, etc.). For convenience, the computing devices 130 will be referred to herein as service center 130.

A satellite broadcast system can be used in place of or contemporaneously with the IPTV media system. In this embodiment, signals transmitted by a satellite 115 can be intercepted by a satellite dish receiver 131 coupled to building 102 which conveys media signals to the media receivers 106. The media receivers 106 can be equipped with a broadband port to the ISP network 132. Although not shown, the communication system 100 can also be combined or replaced with analog or digital broadcast media distributions systems such as cable TV systems. It would be apparent therefore to one of ordinary skill in the art that the present disclosure can be applied to any broadcast media system.

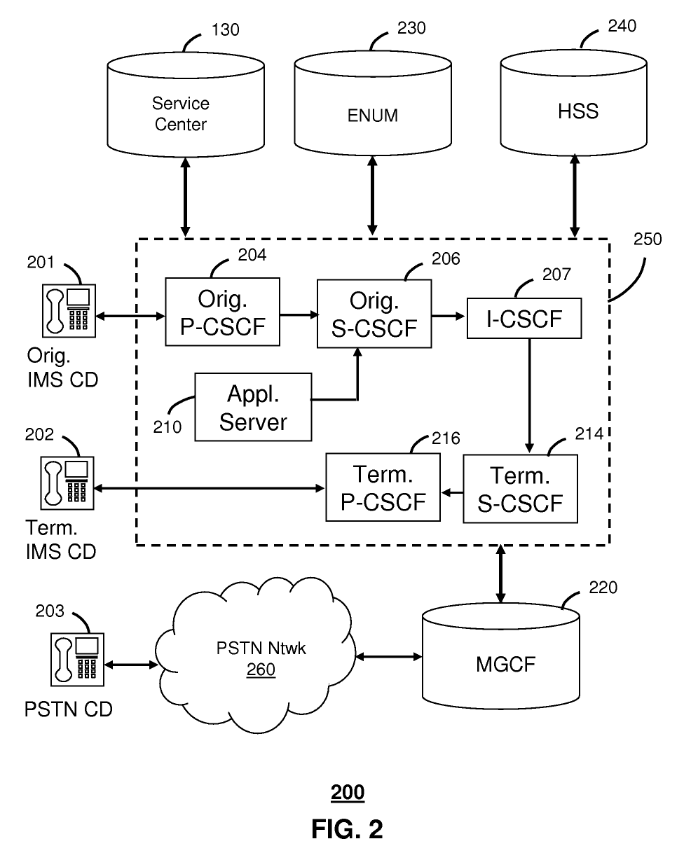

FIG. 2 depicts an exemplary embodiment of a communication system 200 employing an IP Multimedia Subsystem (IMS) network architecture. Communication system 200 can be overlaid or operably coupled with communication system 100 as another representative embodiment of communication system 100.

The communication 200 can comprise a Home Subscriber Server (HSS) 240, a tElephone NUmber Mapping (ENUM) server 230, and network elements of an IMS network 250. The IMS network 250 can be coupled to IMS compliant communication devices (CD) 201, 202 or Public Switched Telephone Network (PSTN) CDs 203 using a Media Gateway Control Function (MGCF) 220 that connects the call through a common PSTN network 260.

IMS CDs 201, 202 can register with the IMS network 250 by contacting a Proxy Call Session Control Function (P-CSCF) which communicates with a corresponding Serving CSCF (S-CSCF) to register the CDs with an Authentication, Authorization and Accounting (AAA) supported by the HSS 240. To accomplish a communication session between CDs, an originating IMS CD 201 can submit a SIP INVITE message to an originating P-CSCF 204 which communicates with a corresponding originating S-CSCF 206. The originating S-CSCF 206 can submit the SIP INVITE message to an application server (AS) such as reference 210 that can provide a variety of services to IMS subscribers. For example, the application server 115 can be used to perform originating treatment functions on the calling party number received by the originating S-CSCF 206 in the SIP INVITE message.

Originating treatment functions can include determining whether the calling party number has international calling services, and/or is requesting special telephony features (e.g., *72 forward calls, *73 cancel call forwarding, *67 for caller ID blocking, and so on). Additionally, the originating S-CSCF 206 can submit queries to the ENUM system 230 to translate an E.164 telephone number to a SIP Uniform Resource Identifier (URI) if the targeted communication device is IMS compliant. If the targeted communication device is a PSTN device, the ENUM system 230 will respond with an unsuccessful address resolution and the S-CSCF 206 will forward the call to the MGCF 220 via a Breakout Gateway Control Function (not shown).

When the ENUM server 230 returns a SIP URI, the SIP URI is used by an Interrogating CSCF (I-CSCF) 207 to submit a query to the HSS 240 to identify a terminating S-CSCF 214 associated with a terminating IMS CD such as reference 202. Once identified, the I-CSCF 207 can submit the SIP INVITE to the terminating S-CSCF 214 which can call on an application server similar to reference 210 to perform the originating treatment telephony functions described earlier. The terminating S-CSCF 214 can then identify a terminating P-CSCF 216 associated with the terminating CD 202. The P-CSCF 216 then signals the CD 202 to establish communications. The aforementioned process is symmetrical. Accordingly, the terms “originating” and “terminating” in FIG. 2 can be interchanged.

The IMS network 250 can also be coupled to the service center 130 previously described in FIG. 1. In this context, the service center 130 can serve to manage subscription and maintenance of triple-play communication services (voice, video and data). The voice services can be wireline or wireless VoIP or PSTN services (e.g., home, office or cell phone). The video services can be IPTV, satellite TV, and/or cable TV services. The data services can be Internet services provided by the ISP network 132 over an xDSL, cable or wireless medium.

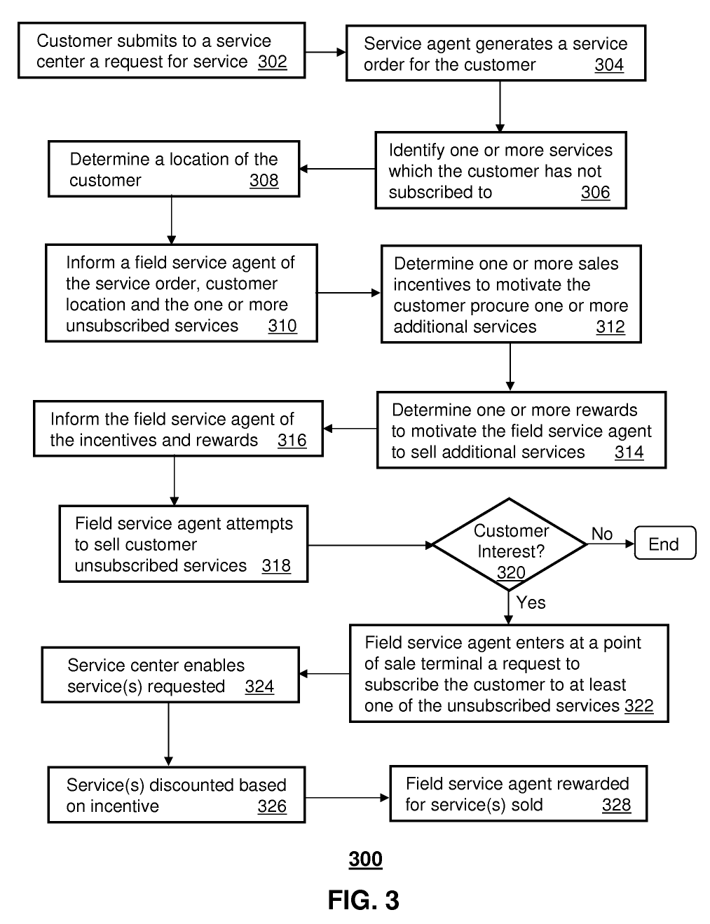

With these principles in mind, FIG. 3 depicts an exemplary method 300 operating in portions of the communication systems 100-200. For convenience, the term communication system 100 as used in the following paragraphs can mean communication systems 100 and 200 singly or in combination. Method 300 begins with step 302 in which a customer submits a request for service to the service center 130. This step can represent a new customer contacting service center 130 by common means (e.g., landline phone, website, etc.) and connecting to a service agent (human, interactive voice response system—IVR, or website registration system) to subscribe to voice, video and/or data services of communication system 100. Alternatively, step 302 can represent an existing customer requesting an upgrade and/or repair of a subscribed service. In step 304, a service agent of the service center 130 (which can be human or synthesized) can generate a service order to fulfill the customer's request.

In step 306, the service center 130 can identify one or more services to which the customer has not subscribed. For example, suppose the customer (new or existing) has subscribed to circuit-switched landline (e.g., PSTN) voice service, but the service center 130 notes that the customer has not subscribed to wireless cellular voice services, or IPTV services. Suppose in another scenario that the customer has been subscribed to circuit-switched landline services for quite some time (e.g., 5 years) but has not inquired about a new Internet-based voice service such as VoIP.

In another embodiment, the service center 130 can be programmed to identify one or more unsubscribed services which the customer is likely to have an interest. For example, the service center 130 can be programmed to select unsubscribed services according to at least one among a behavioral profile of the customer, the customer's age and/or gender, demographic data, or psychographic data. Accordingly, service center 130 can be programmed to target more specifically a customer's potential interests. The service center can further hone in on the interests of the customer by observing a behavioral profile of the customer which can be gathered from observed uses of the services of the communication system 100 (e.g., TV programs viewed, Internet sites viewed, audio channels heard, etc.).

The service center 130 can proceed to step 308 where it determines a location of the customer from a subscriber database, and in step 310 informs a field service agent of the service order, customer location, and the one or more unsubscribed services. The field service agent can represent a technician employed by the service provider of communication system 100 to execute service orders at customer premises. The service order can for example represent an installation of new service, and/or an upgrade or repair of existing service. The field service agent can be receive the service order and the unsubscribed services by an e-mail message or some other suitable communication format. Messages can be transmitted by wireline to a computer terminal of the field service agent, or wirelessly to a portable communication device carried by said agent. The communication device can be a portable point of service (POS) terminal that can receive, process and present messages received over a wireless medium such as provided by cellular base stations 117 shown in FIG. 1. Other suitable wireless access technologies such as WiMAX can be used to exchange messages with the POS terminal of the field service agent.

Method 300 can further determine in step 312 one or more sales incentives to motivate the customer to procure additional communication services. The incentives can be coupons, installation discounts, service fee discounts, or other suitable incentives that might motivate a customer to procure the unsubscribed services identified in step 306. The service center 130 can also be programmed to determine one or more rewards to motivate the field service agent to sell additional services to the customer. The rewards can be for example a commission based on a percentage of the total sales in a month, an end of year raise, a one-time monetary award, or some other suitable form of recognition.

In step 316, the service center 130 can transmit to the POS terminal a message describing the sales incentives determined in step 312 and the complementary reward determined in step 314 if a sale is consummated. With this information, the field service agent can in step 318 attempt to sell the customer the unsubscribed services identified in step 306 before, during or after the service order is fulfilled. If the customer is not interest, method 300 can terminate and is repeated for the next customer. If the customer accepts an offer to subscribe to a new service, and/or upgrade an existing service, the field service agent can in step 322 enter at the POS terminal a request to subscribe to the service(s) for which the customer is interested. In step 324, the service center 130 can direct one or more subsystems of communication system 100 to enable the requested services by common means.

If the services were accepted by the customer based on an offered incentive plan, the field service agent can enter an identification of the incentive plan (e.g., a particular code provided in step 316) with the requested service and in step 326 the service center 130 can inform a billing subsystem of communication system 100 to discount a service fee associated with the requested service(s) indefinitely or on a temporary basis (e.g., 6 month discount) depending on the incentive offered. The service center 130 can also make an accounting of the services sold by the field service agent and in step 328 reward said agent according to the terms agreed to in step 316.

Upon reviewing the aforementioned embodiments, it would be evident to an artisan with ordinary skill in the art that said embodiments can be modified, reduced, or enhanced without departing from the scope and spirit of the claims described below. For example, method 300 can be adapted so that the unsubscribed services are communicated to the field service agent by way of the service order itself. That is, a printed out of the service order can outline the unsubscribed services. Additionally, the customer incentives can be based on presenting a customer new services at no charge during a tryout period. At the expiration of the tryout period, the customer can be queried by the service center 130 whether s/he is interested in continuing the service. In this scenario, the field service agent can also be provided a reward for motivating customers to try out a new service. It would be apparent to an artisan of ordinary skill in the art from these examples that any sales technique can be applied to the present disclosure to augment the revenue potential of the service provider.

These are but a few examples of modifications that can be applied to the present disclosure without departing from the scope of the claims. Accordingly, the reader is directed to the claims section for a fuller understanding of the breadth and scope of the present disclosure.

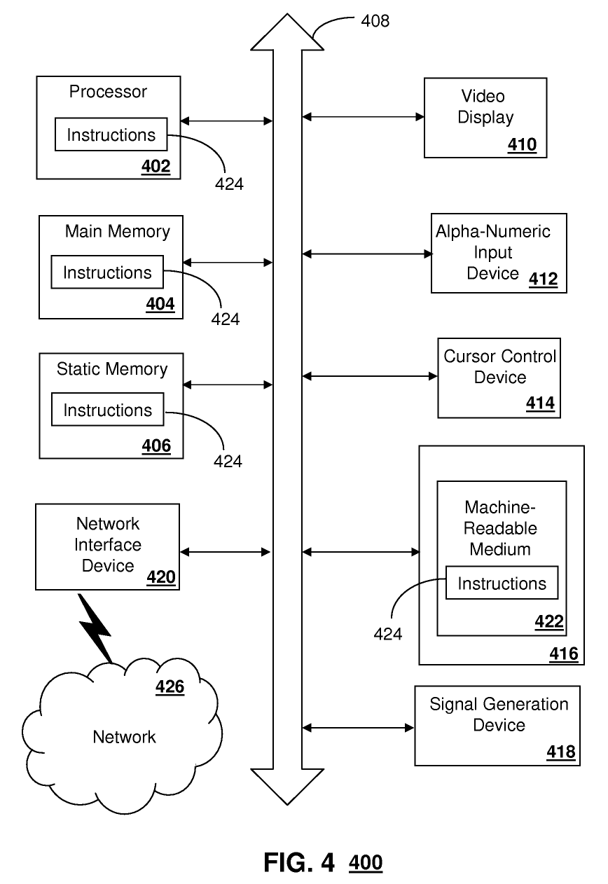

FIG. 4 depicts an exemplary diagrammatic representation of a machine in the form of a computer system 400 within which a set of instructions, when executed, may cause the machine to perform any one or more of the methodologies discussed above. In some embodiments, the machine operates as a standalone device. In some embodiments, the machine may be connected (e.g., using a network) to other machines. In a networked deployment, the machine may operate in the capacity of a server or a client user machine in server-client user network environment, or as a peer machine in a peer-to-peer (or distributed) network environment.

The machine may comprise a server computer, a client user computer, a personal computer (PC), a tablet PC, a laptop computer, a desktop computer, a control system, a network router, switch or bridge, or any machine capable of executing a set of instructions (sequential or otherwise) that specify actions to be taken by that machine. It will be understood that a device of the present disclosure includes broadly any electronic device that provides voice, video or data communication. Further, while a single machine is illustrated, the term “machine” shall also be taken to include any collection of machines that individually or jointly execute a set (or multiple sets) of instructions to perform any one or more of the methodologies discussed herein.

The computer system 400 may include a processor 402 (e.g., a central processing unit (CPU), a graphics processing unit (GPU, or both), a main memory 404 and a static memory 406, which communicate with each other via a bus 408. The computer system 400 may further include a video display unit 410 (e.g., a liquid crystal display (LCD), a flat panel, a solid state display, or a cathode ray tube (CRT)). The computer system 400 may include an input device 412 (e.g., a keyboard), a cursor control device 414 (e.g., a mouse), a mass storage medium 416, a signal generation device 418 (e.g., a speaker or remote control) and a network interface device 420.

The mass storage medium 416 may include a computer-readable storage medium 422 on which is stored one or more sets of instructions (e.g., software 424) embodying any one or more of the methodologies or functions described herein, including those methods illustrated above. The computer-readable storage medium 422 can be an electromechanical medium such as a common disk drive, or a mass storage medium with no moving parts such as Flash or like non-volatile memories. The instructions 424 may also reside, completely or at least partially, within the main memory 404, the static memory 406, and/or within the processor 402 during execution thereof by the computer system 400. The main memory 404 and the processor 402 also may constitute computer-readable storage media.

Dedicated hardware implementations including, but not limited to, application specific integrated circuits, programmable logic arrays and other hardware devices can likewise be constructed to implement the methods described herein. Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations.

In accordance with various embodiments of the present disclosure, the methods described herein are intended for operation as software programs running on a computer processor. Furthermore, software implementations can include, but not limited to, distributed processing or component/object distributed processing, parallel processing, or virtual machine processing can also be constructed to implement the methods described herein.

The present disclosure contemplates a machine readable medium containing instructions 424, or that which receives and executes instructions 424 from a propagated signal so that a device connected to a network environment 426 can send or receive voice, video or data, and to communicate over the network 426 using the instructions 424. The instructions 424 may further be transmitted or received over a network 426 via the network interface device 420.

While the computer-readable storage medium 422 is shown in an example embodiment to be a single medium, the term “computer-readable storage medium” should be taken to include a single medium or multiple media (e.g., a centralized or distributed database, and/or associated caches and servers) that store the one or more sets of instructions. The term “computer-readable storage medium” shall also be taken to include any medium that is capable of storing, encoding or carrying a set of instructions for execution by the machine and that cause the machine to perform any one or more of the methodologies of the present disclosure.

The term “computer-readable storage medium” shall accordingly be taken to include, but not be limited to: solid-state memories such as a memory card or other package that houses one or more read-only (non-volatile) memories, random access memories, or other re-writable (volatile) memories; magneto-optical or optical medium such as a disk or tape; and carrier wave signals such as a signal embodying computer instructions in a transmission medium; and/or a digital file attachment to e-mail or other self-contained information archive or set of archives is considered a distribution medium equivalent to a tangible storage medium. Accordingly, the disclosure is considered to include any one or more of a computer-readable storage medium or a distribution medium, as listed herein and including art-recognized equivalents and successor media, in which the software implementations herein are stored.

Although the present specification describes components and functions implemented in the embodiments with reference to particular standards and protocols, the disclosure is not limited to such standards and protocols. Each of the standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same functions are considered equivalents.

The illustrations of embodiments described herein are intended to provide a general understanding of the structure of various embodiments, and they are not intended to serve as a complete description of all the elements and features of apparatus and systems that might make use of the structures described herein. Many other embodiments will be apparent to those of skill in the art upon reviewing the above description. Other embodiments may be utilized and derived therefrom, such that structural and logical substitutions and changes may be made without departing from the scope of this disclosure. Figures are also merely representational and may not be drawn to scale. Certain proportions thereof may be exaggerated, while others may be minimized. Accordingly, the specification and drawings are to be regarded in an illustrative rather than a restrictive sense.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A computer-readable storage medium, comprising computer instructions for:
receiving from a customer a service request associated with a service provided by a communication system;
generating a service order to fulfill the service request;
identifying one or more services of the communication system to which the customer has not subscribed;
determining a location of the customer;
directing a field service agent to fulfill the service order at the location of the customer; and
informing the field service agent of the one or more unsubscribed services to assist the field service agent in selling at least one among the one or more unsubscribed services.

2. The storage medium of claim 1, comprising computer instructions for:
determining one or more sales incentives to motivate the customer to procure at least one among the one or more unsubscribed services; and
informing the field service agent of the one or more sales incentives.

3. The storage medium of claim 1, comprising computer instructions for receiving a request from the field service agent to subscribe the customer to at least one of the one or more unsubscribed services.

4. The storage medium of claim 3, comprising computer instructions for enabling the at least one of the one or more unsubscribed services.

5. The storage medium of claim 3, comprising computer instructions for discounting a service fee associated with the at least one subscribed to by the customer.

6. The storage medium of claim 1, wherein a service provider of the communication system rewards the field service agent for any additional services procured by the customer.

7. The storage medium of claim 1, comprising computer instructions for:
determining one or more rewards to motivate the field service agent to sell the customer at least one among the one or more unsubscribed services; and
informing the field service agent of the one or more rewards.

8. The storage medium of claim 1, wherein the communication system offers at least one among voice, video and data services.

9. The storage medium of claim 8, wherein the voice service corresponds to one among wireline or wireless circuit-switched voice service and wireline or wireless packet-switched voice service, wherein the video service corresponds to one among cable television (TV) service, satellite TV service, and Internet Protocol TV (IPTV) service, and wherein the data service corresponds to Internet service.

10. The storage medium of claim 1, wherein at least a portion of the communication system comprises an IP Multimedia Subsystem (IMS) network.

11. A communication device, comprising a controller to:
receive from a service center a request directing a field service agent utilizing the communication device to fulfill a service order of a customer, wherein the service order is associated with a service of a communication system;
receive from the service center information identifying one or more services of the communication system to which the customer has not subscribed; and
present the one or more unsubscribed services to assist the field service agent in selling the customer at least one among the one or more unsubscribed services.

12. The communication device of claim 11, wherein the controller is adapted to:
receive from the service center one or more sales incentives for at least one among the one or more unsubscribed services; and
present the one or more sales incentives to assist the field service agent in selling to the customer at least one among the one or more unsubscribed services.

13. The communication device of claim 12, wherein the one or more sales incentives correspond to one or more service discount rates offered to the customer.

14. The communication device of claim 11, wherein the communication device corresponds to a point of sale terminal, and wherein the controller is adapted to:
receive a request from the field service agent to subscribe the customer to at least one of the one or more unsubscribed services; and
transmit the request to the service center.

15. The communication device of claim 11, wherein a service provider of the communication system rewards the field service agent for any additional services procured by the customer.

16. The communication device of claim 11, wherein the controller is adapted to:
receive from the service center a message describing one or more rewards for selling the customer at least one among the one or more unsubscribed services; and
presenting the one or more rewards to the field service agent.

17. The communication device of claim 11, wherein the communication system provides at least one among voice, video and data services, and wherein the voice service corresponds to one among wireline or wireless circuit-switched voice service and wireline or wireless packet-switched voice service, wherein the video service corresponds to one among cable television (TV) service, satellite TV service, and Internet Protocol TV (IPTV) service, and wherein the data service corresponds to Internet service.

18. The communication device of claim 11, wherein at least a portion of the communication system comprises an IP Multimedia Subsystem (IMS) network.

19. A method, comprising presenting a field service agent a service order of a customer and information identifying one or more services of a communication system to which the customer has not subscribed.

20. The method of claim 19, comprising the field service agent using the information to sell the customer at least one among the one or more unsubscribed services.

21. The method of claim 20, comprising the field service agent selling at least one among the one or more unsubscribed services before, during or after the service order is fulfilled.

22. The method of claim 19, comprising:
the field service agent entering at a point of sale terminal a request to subscribe the customer to at least one among the one or more unsubscribed services; and
the point of sale terminal transmitting the request to a service center.

23. The method of claim 19, comprising identifying the one or more unsubscribed services according to at least one among a behavioral profile of the customer, customer age, customer gender, demographic data, and psychographic data.

24. The method of claim 19, comprising informing the field service agent of one or more sales incentive options to assist the field service agent in selling the customer at least one among the one or more unsubscribed services.

25. The method of claim 19, comprising informing the field service agent of one or more rewards for selling the customer at least one among the one or more unsubscribed services.
